(19) United States
(12) Patent Application Publication
(10) Pub. No.: US 2013/0220481 A1
(43) Pub. Date: Aug. 29, 2013

(54) METHOD AND FILLING SYSTEM FOR FILLING CONTAINERS IN A VOLUME AND/OR QUANTITY CONTROLLED MANNER

(71) Applicants: Manfred Hartel, Bretzenheim (DE); Jonathan Lorenz, Bad Kreuznach (DE)

(72) Inventors: Manfred Hartel, Bretzenheim (DE); Jonathan Lorenz, Bad Kreuznach (DE)

(73) Assignee: KHS GmbH, Dortmund (DE)

(21) Appl. No.: 13/876,614

(22) PCT Filed: Sep. 23, 2011
(86) PCT No.: PCT/EP11/04759

§ 371 Date: Mar. 28, 2013

(30) Foreign Application Priority Data
Oct. 11, 2010 (DE) 10 2010 047 883.0

(51) Int. Cl. B67C 3/20

(52) U.S. Cl. CPC B67C 3/20
USPC 141/9; 141/95

(57) ABSTRACT

A filling element includes a channel that forms a delivery opening for delivering filling into a container, a valve arranged in the channel for opening and closing the filling element, the valve being connected by a control valve device to sources for a main and additional component of the filling, and a filling-material section common to the components and forming a space. The element also includes flow meters for measuring volumetric flow of the filling and generating corresponding electrical measurement signals.

The invention relates to a method according to the preamble of patent claim 1 as well as to a filling system according to the preamble of patent claim 9.

“Containers” in the sense of the invention are in particular cans, bottles, tubes, pouches made of metal, glass and/or plastic, as well as other packaging containers suitable for filling liquid or viscous products for a pressurised filling or for a pressureless filling.

The term “open jet filling” in the sense of the invention refers to a method in which the filling material flows to the container to be filled in an open filling jet, with the container not lying with its container mouth or container opening directly against the filling element but being spaced apart from the filling element or from the latter's filling material outlet (delivery opening).

“Filling materials” in the sense of the invention are in particular liquid or flowable products containing solids or solid constituents, e.g. particles and/or fibres, in a liquid or flowable base or matrix, for example fruit or vegetable juices having fruit or vegetable pieces/fibres.

For the purpose of the invention the expression “substantially” means variations from the respective exact value by +/−10%, preferably by +/−5% and/or variations in form of changes insignificant for the function.

Determining the liquid volume of products that are filled in containers by measuring the volumetric flow rate using flow meters, for example by measuring with magnetically inductive flow meters (MID's) which have no moving functional elements and are characterised by high robustness by that fact alone, is a known method.

In the case of products containing solids or solid constituents however, measuring the liquid volume or volumetric flow rate of the filling material that is being delivered to the respective container often causes problems or entails incorrect measurements in particular because during the measurement solids settle on the inner surfaces of the flow meter and/or—especially with magnetically inductive flow meters—the product flowing through these flow meters exhibits a highly variable conductivity owing to the solids, with incorrect measurements occurring as a result. This applies even when products containing such solids or solid constituents are delivered to the container that is to be filled in at least two phases or components, namely in the form of a solids-free or substantially solids-free main component and a proportionally metered additional component which contains the solids or solid constituents in greater concentration but which is still flowable.

The object of the invention is to provide a method which reliably and with great accuracy facilitates a volume-controlled and/or quantity-controlled filling of containers with products containing solids or solid constituents. A method according to claim 1 is configured to resolve this object. A filling system for the volume-controlled and/or quantity-controlled filling of containers is the subject matter of claim 9.

In the case of the invention, the filling of the containers with the product or filling material containing the solids or solid constituents is effected by introducing this filling material into the respective container in the form of at least one solids-free or substantially solids-free main component and separately therefrom with an additional component containing the solids or solid constituents yet still flowable. In the inventive method, the metering or proportioning, i.e. the determining of the fill volume of the additional component, is carried out indirectly by measuring—with a flow meter through which only the at least one solids-free or substantially solids-free main component flows—the volume of main component which is displaced by the volume of the additional component introduced into a storage or proportioning space. Despite the possibility of an accurate metering of the at least one additional component, impairments or incorrect measurements due to solids or solid constituents when determining the volume of this additional component are avoided.

As regards flow meters, for the invention use is made in particular of magnetically inductive flow meters (MID's) which are particularly inexpensive, robust and universally or almost universally usable so far as measuring the volumetric flow rate and hence the volume (time integral of the volumetric flow rate) of liquid products with sufficient electrical conductivity is concerned.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

The invention is explained in detail below through the use of embodiment examples with reference to the figures.

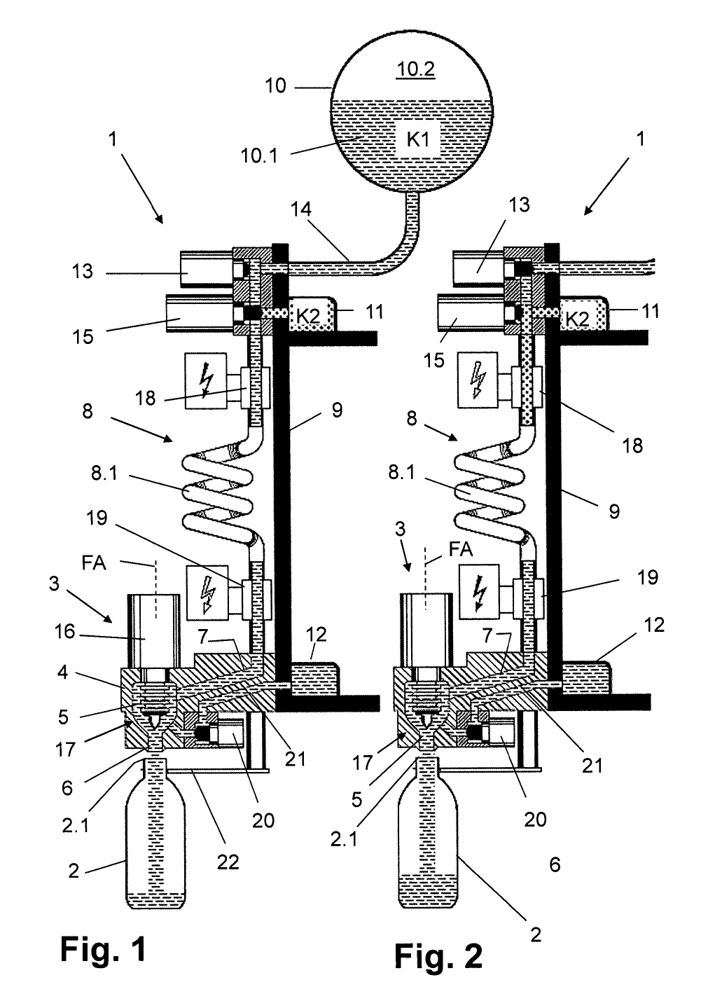

FIGS. 1 and 2 show in simplified schematic diagram a filling system for filling containers with a two-component liquid filling material in different phases or process steps of a filling process;

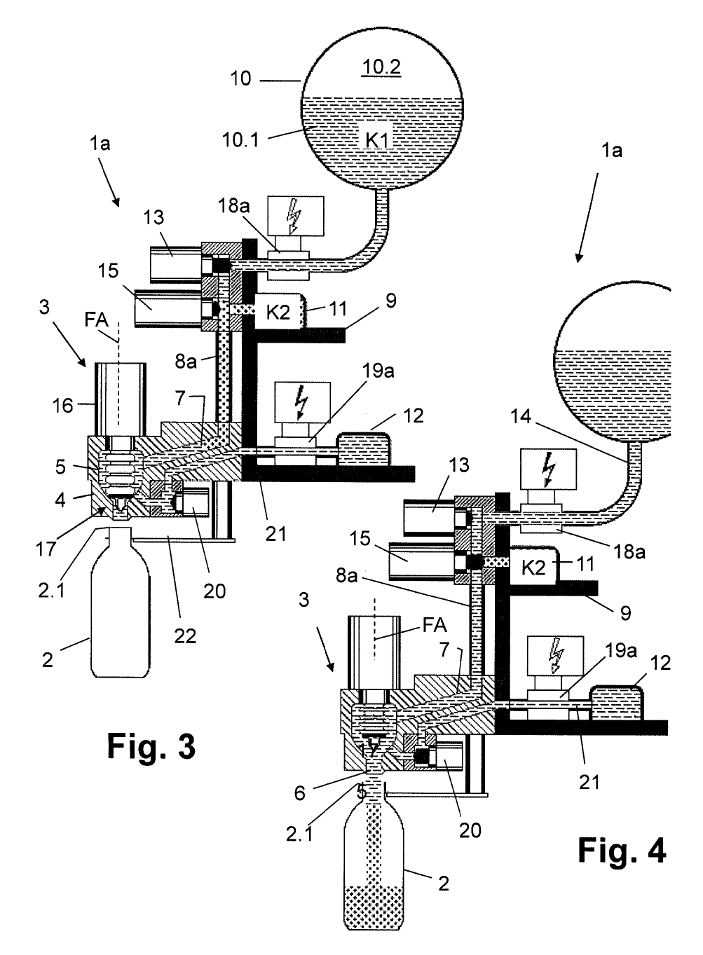

FIGS. 3 and 4 show similar depictions to FIGS. 1 and 2 with an extended embodiment of the inventive filling system.

The filling system generally indicated by 1 in FIGS. 1 and 2 is used for filling containers, which are depicted by way of example as bottles 2, with a liquid filling material which comprises component K1 (main component) and component K2 (additional component), of which component K1 is liquid, i.e. it contains no or substantially no solids or solid constituents such as fruit or vegetable juice, and component K2 which, while still liquid or flowable, contains a high concentration of solids or solid constituents such as fruit or vegetable fibres or fruit or vegetable constituents (including pulp).

The two components K1 and K2 are introduced one after the other into the respective bottle in a filling process in the manner described below in more detail, with the mixing of these components substantially only taking place when they are in respective bottle 2.

Essentially, components K1 and K2 are introduced into respective bottle 2 such that in at least one filling phase of the filling process the required fill volume of component K1 and in at least one filling phase the required fill volume of component K2 is introduced into bottle 2 that is to be filled.

Filling system 1 comprises in the known manner a filling element 3 in whose housing 4 there is provided a liquid channel 5 which forms a delivery opening 6 on the underside of housing 4 and which at its upper region facing away from this delivery opening 6 is connected by a connector 7 to the lower end of a metering or product line 8. Filling element 3 is part of a rotary filling machine and is provided for this purpose together with a plurality of similar filling elements 3 on the periphery of a rotor 9 which is rotationally driven about a vertical machine axis and on which there is provided among other things a tank 10 for component K1, a ring channel 11 for component K2 and a ring channel 12, each for all filling elements 3 of the filling machine in common.

Ring channel 12 forms part of a hot circulation—described below in greater detail—for component K1 by which not only component K1 but also all of the functional elements of filling system 1 which carry that component are held at a high temperature necessary for hot sterile filling.

During filling operations, tank 10 is partially filled in a level-controlled manner with component K1, thereby forming a liquid space 10.1 occupied by component K1 and a gas space 10.2, filled for example with an inert gas, above the liquid surface of component K1.

The upper end of product line 8 can be connected in a controlled manner by a control valve device or a first control valve 13 of that device to liquid space 10.1 of tank 1 via a feeder line 14. The upper end of product line 8 can be connected in a controlled manner by a second control valve 15 of the control valve device to ring channel 11 which carries component K2. Product line 8 and control valves 13 and 15 are provided independently for each filling element 3 of the filling machine.

Inside liquid channel 5 there is provided between connector 7 and delivery opening 6 a liquid valve 17 which can be operated by an operating device 16 and with which—for the volume and/or quantity-controlled delivery of the filling material into respective bottle 2—the connection between connector 7 and delivery opening 6 can in a controlled manner be opened at the beginning of the respective filling process and closed at the end of the filling process as a function of electrical measurement signals of a first flow meter 18 and a second flow meter 19. The two flow meters 18 and 19, which are magnetically inductive flow meters (MID's) for example, each measure and/or capture the volumetric flow rate of component K1 through product line 8 and to this end are disposed in product line 8 spatially apart from each other such that flow meter 18 is located in the region of the upper end of product line 8, i.e. downstream of control valves 13 and 15, and flow meter 19 in the lower region of product line 8 upstream of connector 7. Between the two flow meters 18 and 19, product line 8 forms product line section 8.1 depicted as a coil in FIGS. 1 and 2 and which serves as a storage or proportioning space and whose volume is at least equal to the greatest fill volume of second component K2 that is to be introduced into respective bottle 2 in one process step of the filling process but less than the fill volume of first component K1 that is to be introduced into respective bottle 2 during the filling process.

If filling element 3 is provided for a hot filling, then a liquid connection 21 exhibiting a control valve 20 is further provided in filling element 3 or in housing 4, connecting liquid channel 5 to ring channel 12 in a controlled manner and among other things in such a way that even when liquid valve 17 is closed, i.e. before initiation and/or after completion of the respective filling process, and with control valves 13 and 20 open, a flow connection exists from liquid space 10.1 through product line 8, through liquid channel 5 and through open liquid connection 21 into ring channel 12 and from there via a connection (not shown) exhibiting a heating device back to tank 10 for the hot circulation of component K1.

For open jet filling, respective bottle 2 is arranged with its bottle opening 2.1 below and at a distance away from delivery opening 6, with its bottle axis lying on the same axis as vertical filling element axis FA. In the depicted embodiment, a container carrier 22 associated with each filling element 3 and provided on rotor 9 serves to hold respective bottle 2, holding bottle 2 suspended by a bottle mouth flange.

The modus operandi of filling system 1 can be described as follows:

During filling operations, liquid channel 5—at least upstream of liquid valve 17—connector 7 and product line 8 are completely filled with the filling material, and preferably only with component K1 before the start of the respective filling process. During the respective filling process, control valve 20 is also in the closed state and is not opened for the hot circulation until the end of the respective filling process.

At the beginning of each filling process, with control valves 13 and 20 closed, liquid valve 17 and control valve 15 are opened in a first or preceding process step to allow component K2 to pass from ring channel 11 into product line 8 or product line section 8.1 while displacing part of component K1 hitherto present in product line 8 through opened liquid valve 17 and into bottle 2. The volume of component K1 which is displaced by component K2 from product line 8 equals the volume of component K2 introduced into product line 8 and is measured by flow meter 19 through which only component K1 flows in this process step.

Control valve 15 is closed when the volume measured by flow meter 19 equals the required fill volume of component K2 to be introduced into respective bottle 1. Flow meter 19 therefore measures the partial volume of first component K1 introduced into respective bottle 2 in the preceding process step and at the same time the volume of component K2 that is introduced, i.e. proportioned, into product line 8 or product line section 8.1.

In a second or subsequent process step, with liquid valve 17 still open and control valves 15 and 20 still closed, control valve 13 is opened so that then when product line 18, product line section 8.1, connector 7 and liquid channel 5 are purged with component K1 the entire volume of component K2 initially present, i.e. proportioned, in this product line 8 is introduced into bottle 2 and product line 18, product line section 8.1, connector 7 and liquid channel 5 are once again filled solely and completely with component K1. The volume of component K1 flowing to respective bottle 2 is initially measured with lower flow meter 19 and then later with upper flow meter 18, but in any event in such a way that, for the quantity-based and/or volume-based controlling of the filling process, only the measurement signal of that flow meter 18 or 19 is used through which component K2 or the filling material containing a proportion or remainder of component K2 is not currently flowing.

Taking into account the volumes of product line 8, connector 7 and liquid channel 5 which are determined by the design and hence known, taking into account the volume of component K1 which was already introduced into bottle 2 in the first process step, and possibly also taking into account further filling parameters such as for example the temperature of components K1 and K2 etc., liquid valve 17 and control valve 13 are closed to end the filling process when component K1 is also introduced into respective bottle 2 with the required fill volume. At the end of every filling process, control valve 20 is opened again for the next hot circulation while liquid valve 17 is closed.

The fact that, in filling system 1, control valve 20 is closed throughout the entire filling process effectively prevents component K2 or its constituents from entering ring channel 12 and hence the hot circulation.

In a depiction similar to FIGS. 1 and 2, FIGS. 3 and 4 show a filling system 1a whose only essential difference from filling system 1 is that there are no flow meters provided in the product line indicated by 8a in FIGS. 3 and 4, but instead for each filling element 3 of filling system 1a or of the filling machine concerned, a flow meter 18a and a flow meter 19a are discretely arranged in connecting line 14 and in liquid connection 21 respectively. Otherwise filling system la is the same as filling system 1, so those parts and/or components which in respect of function at least are the same as parts and/or components of filling system 1 are identified in FIGS. 3 and 4 with the same reference numbers as in FIGS. 1 and 2.

The volume of product line 8a and of connector 7 is greater than the volume of component K2 which is introduced into respective bottle 2 in a process step but less than the volume of component K1 to be introduced into respective bottle 2.

The following filling method is for example possible with filling system 1a, with product line 8a, connector 7 and liquid channel 5 upstream of liquid valve 17 being completely filled with component K1 at the beginning of each filling process:

At the beginning of the filling process, in a first or preceding process step, with liquid valve 17 and control valve 13 closed and control valve 20 open, control valve 15 is opened so that component K2 passes from ring channel 11 through control valve 15 into product line 8, thereby at least partially displacing component K1 hitherto present in product line 8a through connector 7, liquid channel 11 and liquid connection 21 into ring channel 12. The volume of displaced component K1 flowing through liquid connection 21 equals the volume of component K2 flowing to product line 8a and is measured by flow meter 19a. As soon as the volume measured by flow meter 19a equals the fill volume of component K2 which is to be introduced into bottle 2, control valve 15 and control valve 20 are closed. The required fill volume of component K2 is now in product line 8a and possibly also partially in connector 7.

In a second or subsequent process step, after control valve 20 is closed, component K1 is introduced from tank 10 into product line 8a by opening liquid valve 17 and control valve 13. As a result, the volume of component K2 therein present is initially introduced into bottle 2 via the liquid connection comprising product line 8a, connector 7 and liquid channel 5 and this liquid connection is completely purged with component K1 so that it is in turn filled solely with component K1. The volume of component K1 flowing to product line 8a from tank 10 is measured by flow meter 18a. Taking into account the volume of the liquid connection between control valve 13 and delivery opening 6 which is determined by the design and hence known, i.e. taking into account the known volumes of product line 8a, connector 7 and liquid channel 5 and possibly also taking into account further filling parameters such as the temperature of components K1 and K2 etc., the closing of liquid valve 17 by operating device 16 and hence the ending of the filling process takes place when component K1 is also introduced into bottle 2 with the required fill volume. At the end of each filling process, control valve 20 is opened again for the hot circulation of component K1 while control valve 13 is still open.

With filling system 1a, the fill volume of component K2 that is to be introduced into respective bottle 2 is also determined not directly but indirectly by the volume of component K1 which is displaced by component K2 and measured with flow meters 18a and 19a.

With filling system 1a, liquid valve 17 is closed during the proportioning of component K2, i.e. during the introduction of this component into product channel 8a. With a rotary filling machine which exhibits this filling system, the proportioning of component K2 can therefore already take place in the angular range of the rotary motion of rotor 9 between a container outlet and a container inlet of the filling machine, i.e. in the so-called “lost angle” of the rotary motion of rotor 9, i.e. before bottle 2 which is to be filled is transferred at the container inlet to the respective filling point formed by filling element 3 and container carrier 22. This significantly increases the angular range of the rotary motion of rotor 9 which can be used for the entire filling process as well as gaining a considerable amount of process time for the filling process, so that among other things a significant increase in the performance of the filling machine (number of bottles 2 filled per unit of time) is also achieved for given machine dimensions (diameter of rotor 9).

Incorrect measurements by flow meters 28, 29 and 28a, 29a due in particular to solid constituents in the filling material are generally avoided by the inventive configuration. The inventive configuration also achieves a high proportioning precision for the introduction of components K1 and K2 into bottles 2 and a high precision of the total fill volume introduced into each bottle 2.

The invention has been described above by reference to embodiments. It goes without saying that numerous variations as well as modifications are possible without departing from the inventive concept underlying the invention. All references in the description thus far have been to volume or fill volume. These terms are of course also equivalent to “quantity” or “fill quantity”.

Thus far the present invention has been explained mainly by reference to filling elements 3 which were provided or suitable for a hot filling of products. It goes without saying of course that other filling elements which are not provided for a hot filling of products or filling materials are suitable for the application of the present invention, so that the present invention/the application of this invention is not confined to filling elements 3 that are suitable for hot filling in spite of the chosen embodiments.

Thus far it has also been assumed that it is only in one process step of the total filling process that component K2 is introduced into the metering and storage space formed by product line section 8.1 or by product line 8a and possibly also partially by connector 7, and in a subsequent process step is brought out of said space with component K1 into bottle 2. It is of course also possible—in particular with correspondingly large-volume bottles 2 or other large-volume containers—to carry out these afore-mentioned process steps twice or multiple times repeatedly in the respective filling process. In each case however the measurement of the fill volume of component K2 is effected indirectly by measuring the volume of component K1 which is displaced by that component, such that the controlling of the filling process can be effected solely by signals from those flow meters 18/19 or 18a/19a through which only component K1, or a filling material which contains component K2 at most in a proportion insignificant for the measurement accuracy and/or measurement certainty, is flowing at the time.

### REFERENCE LIST

1, 1a Filling System
2 Bottle
2.1 Bottle opening
3 Filling element
4 Filling element housing
5 Liquid channel in housing 4
6 Delivery opening
7 Connector
8, 8a Product or metering line
8.1 Product line section
9 Rotor
10 Tank
10.1 Liquid space
10.2 Gas space
11, 12 Ring channel
13 Control valve
14 Connecting line
15 Control valve
16 Operating device
17 Liquid valve
18, 19 Flow meter
18a, 19a Flow meter
20 Control valve
21 Liquid connection
22 Container support
K1, K2 Components of the filling material
FA Filling element axis

1-13. (canceled)

14. A method for quantity-controlled filling of a container with a filling material having a main component and an additional component, said method comprising during a filling process, controlling introduction of said main component and said additional component into said container through a common filling-material section and a filling element by using a flow-metering device associated with said filling element so as to end said filling process when said main component and said additional component have been introduced according to a required fill volume, wherein controlling introduction of said main component and said additional component comprises providing at least two magnetically inductive flow meters for use as a flow-metering device, said magnetically inductive flow meters being spaced apart from one another relative to a direction of flow of said filling material, at the beginning of a filling process, filling said filling-material section and a liquid space of said filling element with only said main component, said liquid space of said filling element being permanently connected to said filling-material section, during said filling process, in at least one preceding process section, introducing said additional component into a space formed by said filling-material section, said space being selected from the group consisting of a storage space and a proportioning space, using at least one of said flow meters through which only said main component flows, indirectly determining a volume of said additional component flowing into said space by measuring a volume of said main component displaced by said additional component from one of said filling-material section and said space, ending introduction of said additional component into said space when a volume of first component displaced by said second component from one of said filling-material section and said space, as measured with at least one flow meter, has reached a particular value, in a subsequent process step, introducing said main component into said filling-material section, through said filling element, and into said container, while concurrently entraining said additional component from said space, and measuring a volume of said main component flowing to said container using at least one flow meter through which only said main component flows.

15. The method of claim 14, further comprising, in said preceding process section, measuring a volume of said main component using at least one of said flow meters downstream of said space in a direction of flow of said filling material.

16. The method of claim 14, further comprising, in a subsequent process section, measuring a volume of said main component using at least one of said flow meters upstream of said space in a direction of flow of said filling material.

17. The method of claim 14, wherein a process sequence consisting of a preceding process step and said subsequent process step is carried out at most once during said filling process.

18. The method of claim 14, wherein a process sequence consisting of a preceding process step and said subsequent process step is carried out at most twice during said filling process.

19. The method of claim 18, said method further comprising, during said preceding process step, causing said main component to be displaced from said space by introducing said additional component into said container to be filled.

20. The method of claim 18, said method further comprising, during said preceding process step, detecting that said filling element is closed, and causing said main component to be displaced from said space into an additional channel from which said main component is returned to a tank for said main component.

21. The method of claim 14, further comprising feeding said main component into said filling-material section by controlled opening and closing of a first control valve, and feeding said additional component into said filling-material section by controlled opening and closing of a second control valve, and using a flow meter through which said main component flows downstream of said first control valve, measuring a volume of said main component in said subsequent process step.

22. The method of claim 14, further comprising feeding said main component into said filling-material section by controlled opening and closing of a first control valve, and feeding said additional component into said filling-material section by controlled opening and closing of a second control valve, and using a flow meter through which said main component flows upstream of said first control valve, measuring a volume of said main component in said subsequent process step.

23. The method of claim 14, further comprising, in a preceding process step, measuring a volume of said main component displaced from said filling-material section using a flow meter provided in said filling-material section downstream of said space in a direction of flow of said filling material.

24. The method of claim 14, further comprising, in a preceding process step, measuring a volume of said main component displaced from said filling-material section using a flow meter provided in a liquid connection connecting a liquid channel of said filling element to said additional channel.

25. The method of claim 24, further comprising closing said liquid connection during said subsequent process step.

26. The method of claim 14, further comprising selecting said additional component to comprise a flowable base of solid constituents, and selecting said main component to be a liquid free of solid constituents.

27. An apparatus for filling containers, said apparatus comprising a filling system for quantity-controlled filling of containers with a filling material comprising a main component and an additional component, said filling system comprising a filling element comprising a liquid channel that forms a delivery opening for delivering said filling material into a container arranged at said filling element, a liquid valve arranged in said liquid channel for controlled opening and closing of said filling element, said liquid valve being connected by a control valve device, which comprises at least two control valves, to a source for said main component and to a source for said additional component, a filling-material section common to said main component and to said additional component and forming a space, said space being selected from the group consisting of a storage space and a proportioning space for proportioning of said additional component, a first flow meter configured for measuring volumetric flow of said filling material and generating a corresponding electrical measurement signal, said first flow meter being arranged in one of said filling-material section downstream of said space in a direction of flow of said filling material and in a controlled connection connecting said liquid channel of said filling element to a channel selected from the group consisting of an auxiliary channel and an additional channel, said controlled connection comprising a further control valve, and a second flow meter configured for measuring volumetric flow of said filling material and generating a corresponding electrical measurement signal, said second flow meter being arranged in one of said filling-material section downstream of said control valve device in said direction of flow of said filling material and in a connection carrying only said additional component upstream of said control valve array in a direction of flow of said main component.

28. The apparatus of claim 27, wherein said first and second flow meters comprise magnetically inductive flow meters.

29. The apparatus of claim 27, wherein said controlled connection extends between said liquid channel and an auxiliary channel when said first flow meter is arranged in said filling-material section.

30. The apparatus of claim 29, wherein said controlled connection between said liquid channel and said auxiliary channel comprises a part of a hot circulation system for said main component.

31. The apparatus of claim 27, wherein said filling-material section is formed by a line selected from the group consisting of a product line and a pipeline between said control valve device and a location selected from the group consisting of said the filling element and a filling material connector of said filling element.

32. The apparatus of claim 31, wherein said line comprises a product line having at least one region in which said product line extends vertically.

33. The apparatus of claim 31, wherein said product line is coil-shaped and forms said space.

34. The apparatus of claim 27, further comprising a rotary filling machine, said rotary filling machine comprising a rotor that rotates about a vertical machine axis, and a plurality of filling elements, wherein said filling system is part of said rotary filling machine, wherein said filling-material section, said control valve arrangement connecting said filling-material section in a controlled manner to said source of said main component and to said source of said additional component, said first and second flow meter, and said additional, controllable connection are provided discretely for each filling element.
